(19) United States
(12) Patent Application Publication
(10) Pub. No.: US 2005/0160153 A1
(43) Pub. Date: Jul. 21, 2005

(54) Publishing multipart WSDL files to URL

(75) Inventors: James Irwin Knutson, Austin, TX (US); Gregory Louis Truty, Austin, TX (US); Ping Wang, Austin, TX (US)

Correspondence Address: BRACEWELL & PATTERSON, L.L.P., P.O. BOX 969, AUSTIN, TX, 78767-0969, US

(73) Assignee: International Business Machines Corp., Armonk, NY (US)

(21) Appl. No.: 10/762,085

(22) Filed: Jan. 21, 2004

(51) Int. Cl. G06F 15/16

(52) U.S. Cl. 709/217; 709/203

(57) ABSTRACT

A method for enabling direct addressing of specific wsdl and/or xsd files within a web services application containing multipart files with relative imports. A virtual addressing scheme allows the files to be identified within a virtual/wsdl/directory that is appended to the endpoint URL. The desired filename is then placed after the virtual directory. When the web container of the web service application receives the endpoint request with the virtual directory, the container recognizes it as a file request and locates the requested file within the endpoint path (or sub-directory within the path). The file is then returned to the requestor along with the SOAP address.

### BACKGROUND OF THE INVENTION

1. Technical Field

The present invention relates generally to computer network applications and in particular to web services applications. Still more particularly, the present invention relates to a method and system for enabling direct client access to multipart files of web services applications.

2. Description of the Related Art

“Web services” are component-based applications on a server that are accessible by client systems via distributed computer networks, such as the Internet. In general, a “web service” is an interface of dynamic content that describes a collection of network-accessible operations. Web Services generally provide access to applications and data over the web through a platform independent, standards-based transport mechanism called Simple Object Access Protocol (SOAP).

Web services are made possible through the utilization of Web Services Definition Language (WSDL), which is an eXtensible Markup Language (XML)-based interface definition language used to define the Web services interface and to describe how to access defined Web services. More specifically, wsdl is used to define the operations supported by a server and how requests and replies for those operations are represented in the messages exchanged between client and server. The wsdl specification is titled “Web Services Description Language (WSDL) 1.1, W3C Note Mar. 15, 2001”, and may be found at the World Wide Web (www) site w3.org/TR/2001/NOTE-wsdl-20010315.

WSDL describes the web services as a set of endpoints, which are typically a remote service that is available at a given URL location. A wsdl document is created/generated for a server hosting a web service and specifies the input and output messages associated with the web service. Each web service stored on the server has a defined endpoint (i.e., an Internet address or Universal Resource Locator (URL) at which the service is located). A wsdl-based description of the defined service endpoints deployed on the “container” is provided in the wsdl document that is published to the clients. The client receives the wsdl description to obtain protocol binding and service description information associated with the defined service endpoint. The client is then able to generate a call request to invoke one or more methods on the defined service endpoint based on the information contained in the received wsdl document. The call request may be received by a runtime system that instantiates and initializes a service endpoint object associated with the defined service endpoint.

Generally, a wsdl document provides three main types of information: (1) the port type (i.e., the interface of the web service); (2) a binding (i.e., the concrete binding of what protocol/format to utilize to communicate with the web services); and (3) an endpoint, which describes the actual (URL) address of the web service itself.

Creation of the web services application involves establishing a web container on the application server (e.g., J2EE application server). Within the web container, each application is defined via an endpoint. One or more of these endpoints are grouped to provide a web service. These endpoints are typically a file at a given URL (e.g., example.com/stock/filename.wsdl). A client seeking access to the web service via the endpoint is provided access to the file located at the endpoint's URL “example.com/stock”.

When the wsdl document for the particular web service is published, the particular endpoint address associated with the web services is sent to the client and is utilized by the client to access the web services application. The web container receives the path (URL) information for accessing that web services application (or set of applications). The web services application's interface is identified utilizing a web services registry, such as Universal Description, Discover and Integration (UDDI). All future access to that web services application requires the client to identify the correct path provided to the web container. For example, assuming the above directory has an endpoint file example.com/stock/foo.wsdl, the corresponding URL required to access foo.wsdl is the URL to the endpoint of the web services application (or http://example.com/stock). When the web container receives a request with that URL, the web container checks its list of published services, and when the particular URL is found, the web container directs the request to the web services provided at “example.com/stock.” The web service then provides the client with access to the foo.wsdl application/file or a result data, based on the invocation of the foo.wsdl application/file.

The above implementation assumes a single accessible file within the endpoint location. However, many current web services provide multiple accessible files within the same level of a published endpoint path. With current methods, a query to the endpoint returns only the outermost one of these multiple files. Some files may be added after the web services application has been published to provide additional services. Others are provided as updates to the earlier published files. With multipart wsdl files, a single wsdl document may reference all documents (i.e., all xsd and wsdl files) within the same directory or subdirectory. Each published service provides a single address path by which the service may be accessed by clients.

With J2EE application servers, (unlike standard web servers that enable access to the subdirectory once access to the main directory is provided), for example, the path to the web container only provides access to a specific directory file. Access to specific files thus requires a retrieval mechanism that identifies the specific file, while maintaining established rules.

There are two types of imports for wsdl files: (1) the absolute import and (2) the relative import. With the absolute import, imported wsdl files are associated with an absolute path, while with a relative import, the imported wsdl files have a path relative to the importing wsdl file. As an example, the absolute import points to a public location at “http://example.com/bondquote.wsdl,” while the relative import points to a file located at the same level of the importing wsdl file or a subdirectory within the endpoint (e.g., “example.com/stock/bonquote.wsdl”). Retrieving the absolute import (with endpoint example.com) is straightforward because the application simply follows the absolute path. For the relative import, however, there is no well-defined way to handle a retrieval of the import from the same level directory or subdirectory of the endpoint.

There are three published requirements for WSDL-based web services, which should be complied with in order to ensure seamless operation of available services. These requirements are:
(1) The implementation should maintain referential integrity. For example, if the URL to access fooimpl.wsdl is http://example.com/stock/fooimp.wsdl and if fooimpl.wsdl imports “foo.wsdl” at the current directory, then the URL for foo.wsdl must be http://example.com/stock/foo.wsdl
(2) The original existing deployment definition (DD) files should not be modified. For example, adding servlet-mapping elements into web.xml should be avoided.
(3) The original wsdl files should not be modified. Thus, converting the relative imports to absolute ones is not allowed.

The web services can be documented via the Universal Description, Discovery and Integration (UDDI) and/or Web Service Inspection Language (WSIL). However, in order to keep the displaying of the wsdl file up to date, the wsdl file often refers back to the original implementation. For example, for AXIS (an open source implementation of the web services), a wsdl query on the services itself is required to retrieve the latest wsdl file. This implementation works well with a single wsdl file. However, when there are multiple wsdl files that import on another file, the wsdl query on the services itself does not necessarily provide the outermost wsdl file. Also, there is no way to derive the correct URL for imports based on the outer-most URL.

An example is now described in which wsdl files of a web service with published endpoint example.com/stock may be accessed according to current implementations. Endpoint “example.com/stock/” is published within the wsdl document, and the URL is registered by the web container. In a first case, the web container has foo.wsdl file at URL example.com/stock (i.e., URL //example.com/stock/foo.wsdl). The ?wsdl query (i.e., example.com/stock ?wsdl) provides foo.wsdl, which is an absolute link. In a second case, the web container has both foo.wsdl and bonquote.wsdl files at URL example.com/stock (//example.com/stock/foo.wsdl and //example.com/stock/bondquote.wsdl). The ?wsdl query (//example.com/stock ?wsdl), however, will only point to the outermost file (e.g., foo.wsdl). There is no way to provide a relative link to bonquote.wsdl using the ?wdsl query as currently implemented. That is, there is no way for a client to point to or access the other file(s) (bondquote.wsdl) without violating established wsdl web services rules under J2EE standard.

As another example, if the outer-most wsdl file (foo.wsdl) can be retrieved via a URL such as “http://example.com/stock/foo ?wsdl”, then based on the referential integrity, the new URL to retrieve the imported bondquote.wsdl has to be “http://example.com/stock/bondquote.wsdl” because the two URLs should have the same leading path if foo.wsdl and bondquote.wsdl are located at the same level of the path address (stock). However, with conventional implementation, the second URL is invalid and cannot be serviced by the web services runtime. Several methods have been suggested to tackle this limitation of ?wsdl when retrieving the relative imports; However, as explained below, each method conflicts with one of the above requirements in one way or another.

In a first method, all relative imports are converted to absolute ones. This method does not comply with the third requirement. Another method attempts to leverage and extend ?wsdl mechanism and provide imported wsdl information in the form of a servlet parameter such as ?wsdl=Foo.wsdl. However, this approach violates the first (or second) requirement and related URL rules. A third method copies wsdl files to the root of the module such as /published-wsdl/directory and treats all files under this directory as resources accessible through the HTTP server. However, not every web container has an extension to service such resources. For example, for WebSphere® web container, customers have to turn on file_Serving_Enabled flag to make the container work, and this flag is normally in the off position.

There is currently no available method to support multipart files without breaching one of the three requirements. It would therefore be desirable to have a method/system that provided multipart support without violating the established laws of wsdl and web services. The present invention provides such a mechanism.

### SUMMARY OF THE INVENTION

Disclosed is a method and system for enabling direct addressing of specific wsdl and/or xsd files within a web services application containing multipart files with relative imports. A virtual addressing scheme is introduced that allows the files to be identified within a virtual/wsdl/directory that is appended to the endpoint URL. The desired filename is then placed after the virtual directory. The web container of the application's server receives the endpoint request with the virtual directory. The URL is first ascertained as being that of an endpoint for one of the published web services application within the web container. Then, once the endpoint is confirmed, the virtual directory request is serviced by the web services application, which reads the appended file name and locates the file within the endpoint path (or subdirectory within the path). The file is then returned to the client along with the SOAP address. Using a virtual wsdl directory that is appended to the URL, the web services application recognizes that the request is not an invocation of the web services but rather a request for the specified file, and the web services application directs the request to the actual file being requested, rather than to the outermost wsdl file at the endpoint directory.

The wsdl files are registered with the applications server when the wsdl document is published. This informs the application server to forward all files with a particular pattern (e.g., wsdl or xsd extension) to the web service application. There is thus a dynamic/virtual registration of the wsdl directory. The registration process includes: (1) registering the file pattern with the server so the server will forward like files to the container; (2) providing the pattern to the client; and (3) allow the client to access the specific file defined by the request that includes the URL, virtual wsdl directory, and file pattern.

The present invention provides a new scheme to retrieve wsdl files other than the “?wsdl” query. The invention is based on implementation of a “/wsdl” virtual directory and its derivatives. With this implementation, an end user who wishes to access the outer-most wsdl file only needs to append “/wsdl” or “/wsdl/” after the web service's endpoint URL. The utilization of this virtual directory and pattern deviates from the regular invocation and allows the client to access the specific wsdl file using the root signature (endpoint URL) to recognize services, along with the virtual directory and appended filename.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a high level diagram illustrating a network (internet) with client and server applications/machines within which the features of the invention may be practiced;

FIG. 2 is a block diagram illustrating components parts of a server, including some network services software components in accordance with one implementation of the invention;

FIG. 3 is a more detailed diagram of the J2EE application server with web container according to one embodiment of the invention;

FIG. 4 is a flow chart illustrating the process of establishing virtual paths and publishing a wsdl document with virtual paths enabled in accordance with one embodiment of the invention;

FIG. 5 is a flow chart illustrating the process of a client preparing and sending a service request with virtual paths and file pattern according to one implementation of the invention;

FIG. 6A is a flow chart illustrating the process by which the web container responds to a receipt of a request with a virtual path and associated file pattern in accordance with one embodiment of the invention; and

FIG. 6B is a flow chart of the new search algorithm utilized with the virtual wsdl directory and associated functionality according to one embodiment of the invention.

### DETAILED DESCRIPTION OF ILLUSTRATIVE EMBODIMENT(S)

The present invention provides a new system for retrieving/accessing wsdl files of published web services applications having multipart files within a single endpoint directory. Unlike the “?wsdl” query, which provides only the outermost wsdl file at the endpoint, the invention enables specific retrieval/access to any one of the multiple files that may be found at the endpoint. The invention is based on the implementation of a virtual “/wsdl” directory and associated functionality. With the virtual wsdl directory, an end user who wishes to access the outer-most wsdl file only needs to append “/wsdl” or “/wsdl/” at the end of normal service URL. To access the specific file, the end user appends “/wsdl/filename” to the endpoint URL, where the “filename” has a preset pattern and is located at the endpoint.

Hardware Considerations

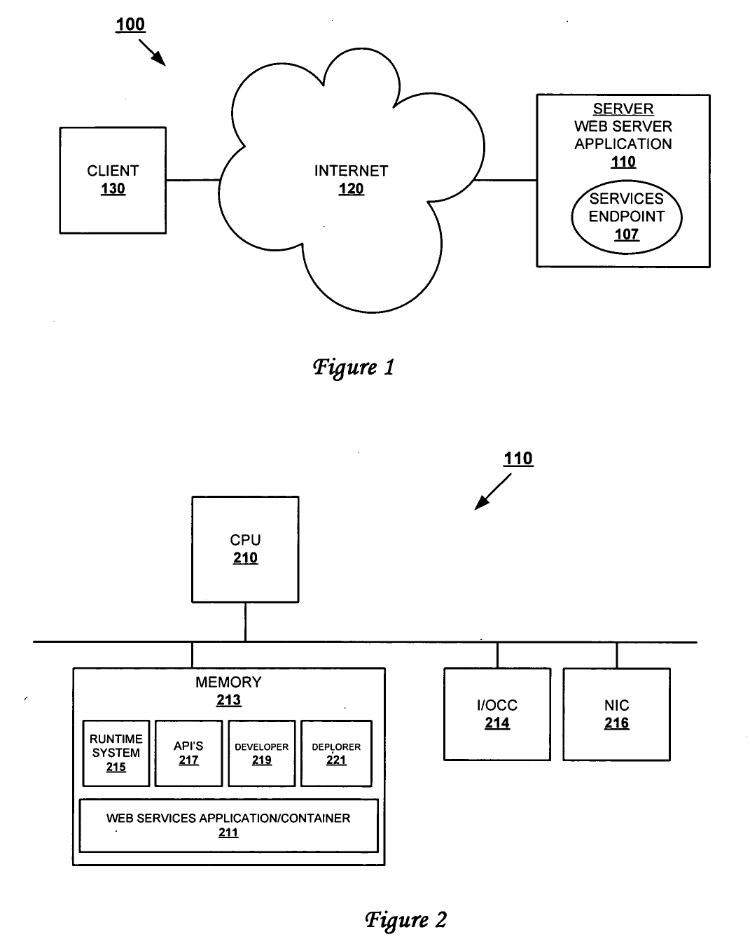

With reference now to the figures, and in particular FIG. 1, which illustrates an exemplary network environment 100 in which features and principles, consistent with the present invention, may be implemented. As shown, environment 100 may include a server 110, network (internet) 120 and a client 130. Network (internet) 120 interconnects server 110 and client 130 and may include one or more communication networks, including for example, the Internet or any other similar network that supports Web-based processing. Although server 110 and client 130 are depicted as separate computing nodes, those skilled in the art will appreciate that server 110 and client 130 may be different processes operating on the same node.

Server 110 may define and maintain resources that may be used by client 130. In one aspect consistent with certain principles related to the present invention, server 110 may maintain one or more services 107, each of which may be a collection of procedures that all callable by remote computing systems, such as client 130. A service may be developed by a user, such as a system developer, operating server 110 using a number of different software development tools, including tools based on the Java programming language. Further, server 110 may employ Remote Procedure Call (RPC) mechanisms that process calls received from client 130 in a manner consistent with certain features related to the present invention. To use a service maintained by server 110, client 130 may also use RPC mechanisms to access the procedures that define a service.

In one configuration consistent with certain features related to the present invention, server 110 and client 130 may implement XML-based RPC mechanisms. In an XML-based RPC, a remote procedure call may be represented using an XML-based protocol, such as the “Simple Object Access Protocol” (SOAP).

Server 110 may be a desktop computer, workstation, mainframe, or any known server side computing system known in the art. Further, server 110 may be configured in a number of different platforms including, but not limited to, the Java 2 Platform Enterprise Edition (J2EE), the Java 2 Standard Edition (J2SE), and non-Java based platforms. In one configuration consistent with certain features related to the present invention, server 110 may implement programming models associated with Java APIs for XML-based RPC (JAX-RPC). Server 110 may be configured similarly to computer system of FIG. 2, and for ease of description, computer system will be assumed to be synonymous with server 110 and hereafter described as server 110. Server 110 comprises a CPU 210, coupled to memory 213, network interface 216, and input/output controller 214.

CPU 210 executes instructions located in memory 213, as well as instructions contained in other memory devices located remote or local to server 110. Input/Output controller 214 provides connection for one or more devices that interface with server 110, such as a keyboard, mouse, display, printer, etc. Network interface 216 is utilized by server 110 to connect to the distributed network and provides the port name and numbers required for that connection.

Stored within memory 213 are an operating system (OS) and software containing instructions executed by CPU 210 to perform functions consistent with certain features related to the present invention. As shown, this software may include, but is not limited to, a server side runtime system 215, server side Application Programming Interface(s) (API(s)) 217, developer 219, and deplorer 221. Further, memory 213 may include memory locations for data, applications, software, etc. such as a container memory location 211 for storing servlet based containers.

Server side runtime system 215 may include a (JAX-RPC) library that provides a set of services that are used for JAX-RPC runtime mechanisms operating within server 110. Server side runtime system 215 is implemented as a standard J2EE container-based JAX-RPC runtime system (including Enterprise Java Beans (EJB) and Web containers).

Server side API 217 is one or more programming interfaces that enable server side JAX-RPC runtime system 215 to communicate with other software operating in server 110. Developer 219 is software that develops a service endpoint associated with a service provided by server 110. Developer 219 is used by an operator of server 110 to define an RPC service that is available to remote computing systems, such as client 130. Deployer 221 provides software that deploys a service on a container maintained by server-side runtime system 215. Container memory 211 is one or more locations in memory 213 that includes servlet containers including servlets and service endpoints that are defined and maintained by server 110. Each service endpoint may include one or more procedures that may be invoked by client 130 remotely over network (internet) 120. Each exported service may be described in a Web Services Description Language (WSDL) document that is posted by server 110 and is available to client 130.

Client 130 of FIG. 1 may be similarly configured to the server computer system of FIG. 2. However, executing within client are client-side software applications, including a client-side runtime system, client-side API, provider, deployer, and client application. Client 130 may use JAX-RPC based mechanisms to generate and communicate calls to server 110 in a manner consistent with certain features related to the present invention.

Although FIG. 1 shows only one client 130 and server 110, one skilled in the art would realize that computing environment 100 may include a plurality of clients 130 and/or servers 110 without departing from the scope of the present invention. Additionally, one skilled in the art would realize that the configuration of client 130 and server 110 described above is not intended to be limiting. That is, server 110 and client 130 may include additional (or less) hardware, processes, software, etc., than that shown in FIGS. 1 and 2 without departing from the scope of the present invention.

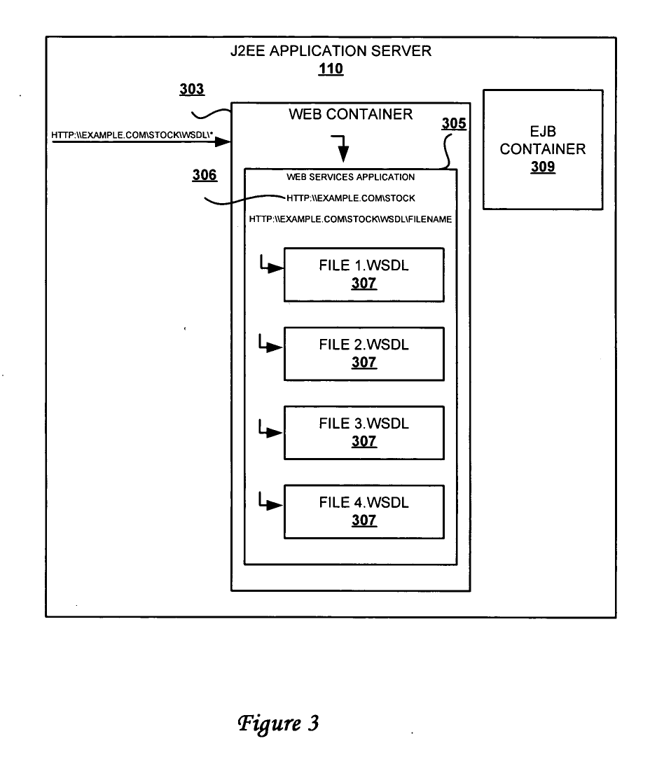

FIG. 3 provides another look at server 110 from the perspective of the functional processes being provided by interaction and execution of the various components illustrated by FIG. 2. According to the invention, server 110 is configured as a J2EE application server and includes a web container 303 and an EJB container 309. Web container 303 contains a web services application 305, having a published URL endpoint 306. For illustration, web container 303 is depicted with four files 307, which may be either wsdl files or xsd files in the described embodiment. It is understood that web container 303 may contain a single file or multiple files and may also contain sub-paths within which the files are stored/located. The features of the invention are applicable to web container 303 regardless of the number of files and/or the exact location within the endpoint directory or subdirectory. An invocation of the web services application is made using the endpoint URL, while retrieval of a specific wsdl file from the endpoint is completed via a request containing the endpoint URL with the virtual wsdl directory and filename appended thereto.

The endpoint URL \\example.com\stock defines the host port for access to the web services application and path within the host at which the web services is found. The virtual wsdl directory and filename appended to the endpoint URL is recognized by the web container as a request for return of a specific file and not an invocation of the web service. Unlike conventional implementation of web containers, the current implementation of Websphere container allows registering of certain patterns with the container and dynamic/virtual functionalities described herein.

Invention Implementation

In order to fully implement the features of the invention, certain definitions are required for events/elements that are not clearly defined in the currently available public specification for web service applications that implement enterprise web services. For example, the current specification does not define (1) where to place wsdl files or (2) where to find soap addresses, etc. Thus, the invention first defines these previously undefined items and provides the following requirements for implementation of the invention:
(1) All wsdl files are placed within a single directory, “WEB-INF/wsdl/” or “META-INF/wsdl/”; and
(2) All soap addresses only appear in the outer-most wsdl file.

Thus, with one implementation of the invention, all wsdl files are located at “<module-root>/WEB-INF/wsdl/” or “<module-root>/META-INF/wsdl/” directory, which makes file publishing very straightforward. With these requirements in place, the invention provides a solution that maps correct URL to multipart files in a web service application having a defined/published endpoint. The files are published on the fly with certain elements updated (such as soap addresses).

In general, the wsdl file is static and its soap address contains a fixed host and port. When a system administrator changes the environment where the application is deployed, a manual update of the wsdl soap address is often required to reflect this change. For example, if the administrator changes the webcontainer port, then the port within soap address has to be updated accordingly. This process is very cumbersome and is prone to errors. In one implementation, the invention also allows the dynamic update of wsdl soap address to reflect the actual application deployment. The invention thus provides the ability to update the soap address dynamically based on the current deployment configuration.

The invention introduces a new semantic in place of “?wsdl”. This semantic is a virtual wsdl directory or “/wsdl” which is appended to the endpoint URL. Accordingly, in order to access the outer-most wsdl file, the end user only needs to append “/wsdl” or “/wsdl/” at the end of the SOAP address (i.e., URL of the web service). For example, if the soap address for “foo” service is “http://example.com/stock/foo” then the simplest way to obtain foo's outer-most wsdl is “http://example.com/stock/foo/wsdl” or “http://example.com/stocklfoo/wsdl/”. Upon receiving this URL at the server, the request is redirected to “http://example.com/stock/foo/wsdl/fooimpl.wsdl”, where fooimpl.wsdl is the name of outer-most wsdl file. If fooimpl.wsdl has an import such as “<import namespace=“http://example.com/foo” location=“a/b/foo.wsdl”>, then the URL to read foo.wsdl is derived as “http://example.com/stock/foo/wsdl/a/b/foo.wsdl”, based on the required referential integrity.

For a specific file name, the invention allows the appending of a wildcard, such as “/wsdl/filename”, where the wild card (filename) follows the pattern of the wsdl and/or xsd files. This pattern is established when the files are installed within the application. If a filename having the correct pattern is received, the specific file is found within the virtual wsdl directory and returned to the client.

Once the requirements have been established and defined, certain additional runtime changes are made to enable the wsdl files accessible through URL. The first major change involves adding an associated wsdl accessing URL-pattern at the runtime initialization phase for URL pattern of each registered service. For instance, if a mapping of “/stock/foo” to a servlet is made, then a corresponding mapping of “/stock/foo/wsdl/*” to the same servlet is to be completed. Notably, the implementation by which the wild card (*) is added does not violate the protocol specification because the wild card is used to access wsdl files, and not the service.

The invention introduces several web services runtime elements in order to make the wsdl files accessible through the type of URL defined above. These elements are provided below along with their definitions and/or description of their specific implementation/application.

This first change provides a dynamic servlet registration. When the webcontainer runtime is initialized, a corresponding wsdl accessing URL-pattern is generated for each URL mapping of web services servlet. For example, to map “/services/foo” to Foo web services servlet, a new mapping is added from “/services/foo/wsdl/*” to the same Foo servlet and this mapping is dynamically registered with the webcontainer.

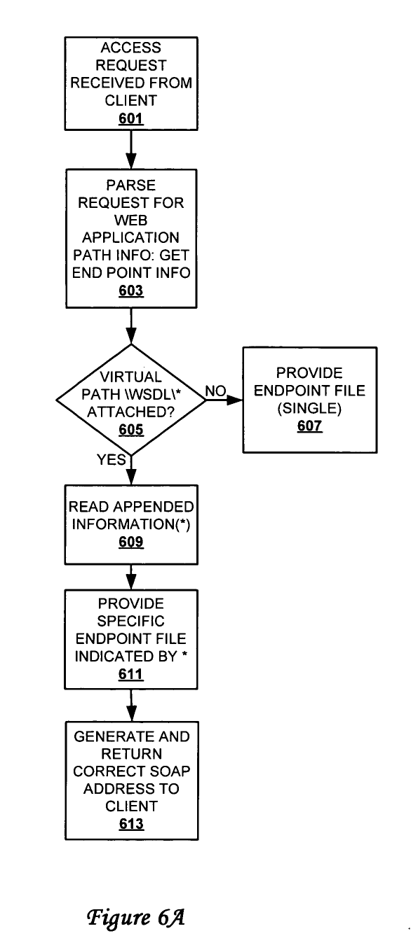

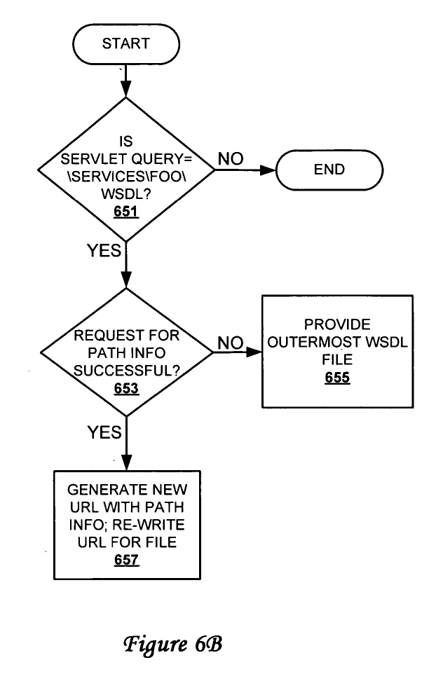

The second runtime change involves a modification of the servlet so that the servlet is able to recognize and handle this new URL pattern. This change involves a new wsdl search algorithm. The internal web services servlet is modified so that the servlet can recognize and handle the new form of URL pattern. A text version of the algorithm utilized to accomplish this task is provided by FIG. 6B, and described below using foo/fooimpl.wsdl as an example file.

The process begins with a determination at block 651 whether the query to obtain the servlet path (or API) is equal to “/stock/foo/wsdl”. If the query is equal to /stock/foo/wsdl, then the request is recognized as targeting certain wsdl files. A next check is made at block 653 to obtain the servlet path information. When the second check returns a null, empty or “/”, then the checking utility recognizes that the request is synonymous with the “?wsdl” as shown at block 655, and the request is redirected to the outer-most wsdl file, which is fooimpl.wsdl, according to the example.

However, if the check returns a non-empty string (e.g., a/b/bondquote.wsdl), then the URL is rewritten and a new URL is generated, as indicated at block 657. For example, the new URL may be “http://example.com/stock/services/foo/wsdl/fooimpl.wsdl”. As previously stated, fooimpl.wsld is located at “<module-root>/WEB-INF/wsdl/” (javaBean) or “<module-root>/META-INF/wsdl (ejb). As another example, the generated URL may be as “http://example.com/stock/services/foo/wsdl/a/b/bondquote.wsdl” when the actual bond.wsdl file is located at “<module-root>/WEB-INF/wsdl/a/b/bond.wsdl”.

The above scheme of the invention satisfies the “relative URL” requirement. For example, fooimpl.wsld imports foo.wsdl which is at the same directory as fooimpl.wsdl. If the URL to access fooimpl.wsdl is “http://example.com/stock/services/foo/wsdl/foolmpl.wsdl”, the mapping rules require “http://example.com/stock/services/foo/wsdl/foo.wsdl” for foo.wsdl file. This mapping is correct with the proposed scheme.

In addition to the above two changes, a third change provided by the invention involves a dynamic update of wsdl soap addresses. The wsdl soap address is often composed of three parts, host, port and servlet path. The scheme introduced with this invention is constructed so that any incoming wsdl request URL contains enough information to recreate the wsdl soap address dynamically. Such information includes all the elements of a valid wsdl soap address, i.e., host, port, and servlet path.

The invention assumes that the information is valid since this wsdl request is able to reach this far to the web services runtime. Therefore, this information may be used to update the static wsdl soap address. Thus, the correct soap address may be recreated for the wsdl file even if the initial soap address provided is incorrect or completely wrong. For example, suppose the incoming wsdl request URL is “http://example.com/quote/services/stockquote/wsdl”, then it is known that the soap address for this wsdl is “http//example.com/quote/services/stockquote” based on the above described scheme of the invention. The wsdl files may therefore be updated as such.

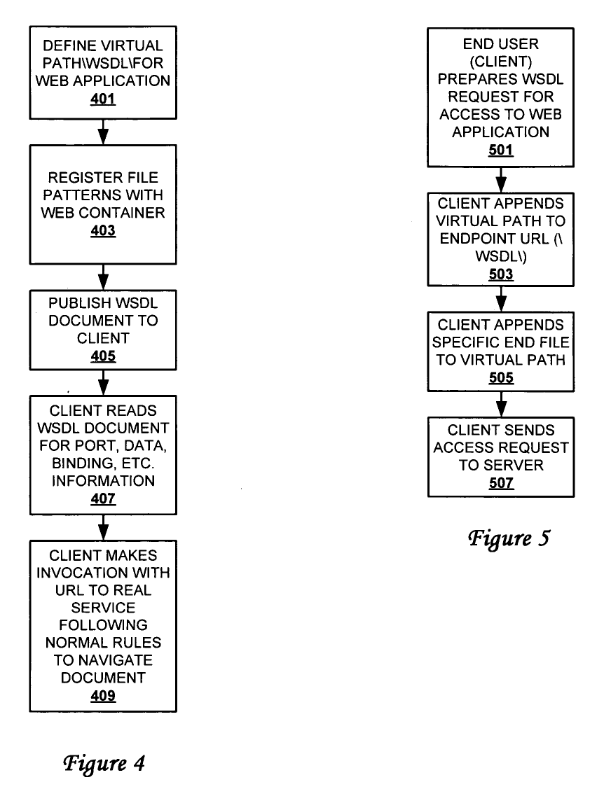

Referring now to the figures, three high level flow charts are provided illustrating processes by which the virtual wsdl directory is set up and utilized to respond to an end user's request for access to a specific file in a web service. FIG. 4 illustrates the process of setting up the virtual directory and begins at block 401, which illustrates the application programmer defining the virtual path for the web application. The virtual path is then provided within the wsdl document and the pattern for the files are registered with the web container, as shown at block 403. The wsdl document is then published as shown at block 405. The document is received and read by the end user at the client as indicated at block 407. Notably, the other standard web services information are also obtained from the wsdl document, e.g., port, data type, binding. Having read the wsdl document, the end user is made aware of the virtual path, method of use and also the file pattern to utilize with the path as indicated at block 409.

FIG. 5 illustrates the process of the client preparing and sending a request for retrieving a specific file located at the endpoint URL. The process begins at block 501, which illustrates the end user of the client preparing the wsdl request. During preparation, the end user appends the virtual path (/wsdl) to the endpoint URL as shown at block 503. The end user then appends the wildcard or specific file after the virtual wsdl directory as shown at block 505. Then, the end user transmits the request to the server as shown at block 507.

FIG. 6A illustrates the response by the server to the receipt of the wsdl query having a virtual wsdl directory and wildcard. The process begins with the server receiving an access request from the client, as shown at block 601. The request is parsed by the web container for web application information and endpoint information as shown at block 603. When the application is confirmed as being on the web server, a determination is made at block 605 whether there is a virtual wsdl path and wildcard attached to the received URL. If there is no wild card (or if there is no virtual path), the endpoint file within the directory is provided as indicated at block 607. However, if there is a virtual wsdl path with a wildcard, the wildcard information is read and matched against the files located within the endpoint directory as depicted at block 609. The specific file within the endpoint directory is then accessed as shown at block 611. A correct SOAP address for the file is then created and returned to the client as depicted at block 613.

The utilization of this virtual directory schema and pre-defined file pattern deviates from the regular invocation and allows the client to access the specific wsdl file using the root signature (endpoint URL) to recognize services, along with the virtual directory and appended file pattern.

Also, it is important to note that while the present invention has been described in the context of a fully functional data processing system, those skilled in the art will appreciate that the mechanism of the present invention is capable of being distributed in the form of a computer readable medium of instructions in a variety of forms, and that the present invention applies equally, regardless of the particular type of signal bearing media utilized to actually carry out the distribution. Examples of computer readable media include: nonvolatile, hard-coded type media such as Read Only Memories (ROMs) or Erasable, Electrically Programmable Read Only Memories (EEPROMs), recordable type media such as floppy disks, hard disk drives and CD-ROMs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

1. A method for enabling remote access to and retrieval of files of a web services application, said method comprising:
defining a virtual directory within a web container hosting the web services application, said virtual directory specifying a location of specific list of files having a given pattern, wherein said web container recognizes requests that include said virtual directory;
registering each file pattern of said files with said web container; and
when a request is received with said virtual directory appended to a universal resource locator (URL) of the web services application, recognizing said client request as a request to retrieve one of said files.

2. The method of claim 1, further comprising:
receiving the request from a requestor;
analyzing said request to determine if said request contains the virtual directory appended to the URL; and
when said request does not contain the virtual directory, initiating an invocation of the web services application corresponding to said URL and providing said requestor with access to functionality of said web services application.

3. The method of claim 1, further comprising:
storing each of said files with predefined file patterns at a pre-specified directory path within said web container, which path is associated with an endpoint directory of said web services application, wherein all file searches occur within said pre-specified directory and subdirectories affiliated therewith.

4. The method of claim 3, wherein said step of recognizing said request as a request for retrieval of a file further comprises:
identifying whether a filename is appended to said virtual directory; and
when no filename is appended to said virtual directory, returning an outermost file from said pre-specified directory to said requestor.

5. The method of claim 4, wherein, when a filename is appended to said directory, said method further comprises:
determining whether said filename has a correct predefined pattern;
when said filename has said correct predefined pattern, searching said pre-specified directory for said filename; and
when said filename is found, returning said copy of said file from said pre-specified directory to said requestor.

6. The method of claim 5, further comprising:
generating a correct Simple Object Access Protocol (SOAP) address for said file; and
returning said SOAP address along with said copy of said file to said requestor.

7. The method of claim 5, further comprising:
returning an error message indicating that said filename does not exist within said pre-specified directory when the filename does not have a correct predefined pattern; and
returning an outermost file from said endpoint directory to said requestor and messaging said requester that the filename does not exist when the filename does have a correct predefined pattern but is not found within said pre-specified directory.

8. The method of claim 1, further comprising:
registering said filenames and predefined patterns with the applications server, wherein said applications server recognizes that a request for a file having said pattern is found at a pre-established directory.
encoding an automatic response by said applications server, wherein said applications server automatically forwards all requests for files with said predefined pattern to the web container hosting the web services application; and
providing the file pattern to a requestor during a publication of the web services application's wsdl (web services definition language) document.

9. The method of claim 1, further comprising:
adding an associated wsdl accessing URL-pattern at a runtime initialization phase for URL pattern for each registered web services application;
providing dynamic servlet registration, wherein when a web container runtime is initialized, a corresponding wsdl accessing URL-pattern is generated for each URL mapping of web services servlet; and
modifying said servlet to be able to recognize and handle the new URL pattern via a wsdl search algorithm.

10. The method of claim 9, further comprising:
implementing said search algorithm according to established criteria from among (1) maintaining referential integrity among filenames and their root directory; (2) non-modification of original existing deployment definitions files; and (3) non-modification of original wsdl files.

11. The method of claim 9, wherein said adding step includes:
placing all wsdl files within a single predefined directory; and
enabling all soap addresses to only appear in an outermost file.

12. A web server comprising:
a web services application having an associated URL by which remote access to the web services application is provided; and
a web container hosting said web services application, said web container having a plurality of web services servlets and mechanism to:
add an associated wsdl accessing URL-pattern at a runtime initialization phase for URL pattern for each registered web services application;
provide dynamic servlet registration, wherein when a web container runtime is initialized, a corresponding wsdl accessing URL-pattern is generated for each URL mapping of web services servlet; and
modify said servlet to be able to recognize and handle the a new URL pattern via a wsdl search algorithm.

13. The web server of claim 12, further comprising:
means for implementing said search algorithm according to established criteria from among (1) maintaining referential integrity among filenames and their root directory; (2) non-modification of original existing deployment definitions files; and (3) non-modification of original wsdl files.

14. The web server of claim 12, wherein said web container mechanism to add wsdl accessing URL-pattern includes:
a single predefined directory within which all wsdl files are placed; and
means for enabling all soap addresses to only appear in an outermost file of said predefined directory.

15. The web server of claim 12, further comprising:
means for registering said filenames and predefined patterns with the applications server, wherein said applications server recognizes that a request for a file having said pattern is found at a pre-established directory.
means for encoding an automatic response by said applications server, wherein said applications server automatically forwards all requests for files with said predefined pattern to the web container hosting the web services application; and
means for providing the file pattern to a requestor during a publication of the web services application's wsdl (web services definition language) document.

16. The web server of claim 12, further comprising:
means for defining a virtual directory within a web container hosting the web services application, said virtual directory specifying a location of specific list of files having a given pattern, wherein said web container recognizes requests that include said virtual directory;
means for registering each file pattern of said files with said web container; and
means, when a request is received with said virtual directory appended to a universal resource locator (URL) of the web services application, for recognizing said request as a request to retrieve one of said files.

17. The web server of claim 12, further comprising:
means for receiving the request from a requestor;
means for analyzing said request to determine if said request contains the virtual directory appended to the URL; and
means, when said request does not contain the virtual directory, for initiating an invocation of the web services application corresponding to said URL and providing said requestor with access to functionality of said web services application.

18. The web server of claim 12, further comprising:
means for storing each of said files with predefined file patterns at a pre-specified directory path within said web container, which path is associated with an endpoint directory of said web services application, wherein all file searches occur within said pre-specified directory and subdirectories affiliated therewith.

19. The web server of claim 12, wherein said means for recognizing said client request as request for retrieval of a file further comprises:
means for identifying whether a filename is appended to said virtual directory; and
means, when no filename is appended to said virtual directory, for returning an outermost file from said pre-specified directory to said requester; and
means, when a filename is appended to said directory and has a correct predefined pattern, for:
searching said pre-specified directory for said filename; and
when said filename is found, returning said copy of said file from said pre-specified directory to said requestor;
generating a correct Simple Object Access Protocol (SOAP) address for said file; and
returning said SOAP address along with said copy of said file to said client.

20. A computer program product, comprising:
a computer readable medium; and
program code on said computer readable medium for providing a web server application that includes:
program code for implementing a web services application having an associated URL by which remote access to the web services application is provided; and
program code for enabling functionality to a web container hosting said web services application, wherein said web container contains a plurality of web services servlets, said functionality including:
adding an associated wsdl accessing URL-pattern at a runtime initialization phase for URL pattern for each registered web services application;
providing dynamic servlet registration, wherein when a web container runtime is initialized, a corresponding wsdl accessing URL-pattern is generated for each URL mapping of web services servlet; and
modifying said servlet to be able to recognize and handle the a new URL pattern via a wsdl search algorithm.

21. The computer program product of claim 20, further comprising:
program code for implementing said search algorithm according to established criteria from among (1) maintaining referential integrity among filenames and their root directory; (2) non-modification of original existing deployment definitions files; and (3) non-modification of original wsdl files.

22. The computer program product of claim 20, wherein said code for enabling web container functionality to add wsdl accessing URL-pattern includes:
program code for identifying a single predefined directory within which all wsdl files are placed; and
program code for enabling all soap addresses to only appear in an outermost file of said predefined directory.

23. The computer program product of claim 20, further comprising:
program code for registering said filenames and predefined patterns with the applications server, wherein said applications server recognizes that a request for a file having said pattern is found at a pre-established directory;
program code for enabling an automatic response by said applications server, wherein said applications server automatically forwards all requests for files with said predefined pattern to the web container hosting the web services application; and
program code for providing the file pattern to a client during a publication of the web services application's wsdl (web services definition language) document.

24. The computer program product of claim 20, further comprising:
program code for defining a virtual directory within a web container hosting the web services application, said virtual directory specifying a location of specific list of files having a given pattern, wherein said web container recognizes requests that include said virtual directory;
program code for registering each file pattern of said files with said web container; and
program code for recognizing said request as a request to retrieve one of said files, whenever a request is received with said virtual directory appended to a universal resource locator (URL) of the web services application.

25. The computer program product of claim 20, further comprising:
program code for receiving the request from a requester;
program code for analyzing said request to determine if said request contains the virtual directory appended to the URL; and
program code for initiating an invocation of the web services application corresponding to said URL and providing said requestor with access to functionality of said web services application, when said request does not contain the virtual directory.

26. The computer program product of claim 20, further comprising:
program code for storing each of said files with predefined file patterns at a pre-specified directory path within said web container, which path is associated with an endpoint directory of said web services application, wherein all file searches occur within said pre-specified directory and subdirectories affiliated therewith.

27. The computer program product of claim 20, wherein said program code for recognizing said request as request for retrieval of a file further comprises:
program code for identifying whether a filename is appended to said virtual directory; and
program code for returning an outermost file from said pre-specified directory to said requester when no filename is appended to said virtual directory; and
program code, when a filename is appended to said directory and has a correct predefined pattern, for:
searching said pre-specified directory for said filename; and
when said filename is found, returning said copy of said file from said pre-specified directory to said requestor;
generating a correct Simple Object Access Protocol (SOAP) address for said file; and
returning said SOAP address along with said copy of said file to said requestor.

28. The computer program product of claim 27, further comprising:
program code for returning an error message indicating that said filename does not exist within said pre-specified directory when the filename does not have a correct predefined pattern, and
program code for returning an outermost file from said endpoint directory to said requester and messaging said requestor that the filename does not exist when the filename does have a correct predefined pattern but is not found within said pre-specified directory.

29. A method for retrieving files from an endpoint directory of a web services application, comprising:
generating a file request containing a URL of the endpoint directory of the web services application;
adding a name of a virtual directory after the URL, said virtual directory name being assigned at a web server to host a plurality of files at the endpoint directory;
forwarding said file query with said URL and appended virtual directory to a web container hosting said web services application, wherein said adding of said virtual directory to said URL is recognized as a file retrieval request by the web server and results in a retrieval of a copy of a corresponding file in response.

30. The method of claim 29, further comprising:
appending to said virtual directory name a particular filename of the file that is being requested;
wherein said retrieval provides a copy of the file identified by said filename at said web container.

31. The method of claim 30, wherein when said file is located within a sub-directory of said endpoint directory, said filename comprises a subdirectory delimiter appended to said virtual directory.

32. The method of claim 29, further comprising:
generating said file request based on a published wsdl document of said web services application, which document provides said URL, and file retrieval information including a name of said virtual directory and a file pattern;
receiving a response from said web container;
wherein said response includes an outermost file within an endpoint directory of said web services application when no filename is appended to said virtual directory within the file request; and
wherein said response includes (1) the specific file associated with the filename that is appended to the virtual directory in the file request when that filename has a correct file pattern and (2) a soap address of the specific file.

33. The method of claim 29, wherein said virtual directory is a /wsdl directory and said file pattern includes a wsdl pattern and an xsd pattern.
